(19) United States
(12) Patent Application Publication
(10) Pub. No.: US 2008/0056864 A1
(43) Pub. Date: Mar. 6, 2008

(54) TRANSPORTED OBJECT STORAGE SYSTEM

(75) Inventors: Yoshiya WADA, Ise-shi (JP); Tatsuo TSUBAKI, Ise-shi (JP); Masanao MURATA, Ise-shi (JP)

Correspondence Address: YOUNG & THOMPSON, 745 SOUTH 23RD STREET, 2ND FLOOR, ARLINGTON, VA, 22202, US

(73) Assignee: ASYST SHINKO, INC., ISE-SHI (JP)

(21) Appl. No.: 11/848,270

(22) Filed: Aug. 31, 2007

(30) Foreign Application Priority Data
Sep. 1, 2006 (JP) 2006-237198

(51) Int. Cl. B65G 1/10; G05B 13/00

(52) U.S. Cl. 414/331.01; 700/28

(57) ABSTRACT

A transported object storage system includes: a transporting carriage traveling along a track and transporting objects each having a gripped portion; a transported object storage rack having a rack board; a positioning plate on the rack board and on which the transported objects are put, having a plurality of groups of projections, each of the groups supporting respective one of the transported objects by engaging with a group of concave portions formed on a bottom surface of the respective one of the transported objects; and a plurality of code informations attached at predetermined intervals of the track. The transporting carriage is provided with a code information reading device for reading the plurality of code informations, a gripper for gripping the gripped portion and (iii) a correcting device for correcting a stop position of the transporting carriage along the track.

### BACKGROUND OF THE INVENTION

1. Field of the Invention

The present invention relates to a transported object storage system for temporarily storing or stocking a transported object, which is transported by a transporting carriage in a factory or the like. Here, the “transported object” means a product, an intermediate product, a part, an article, a work, a partly-finished good, a good or the like, or means a box or container for containing such a product or the like, which has been transported or is to be transported by the transporting carriage.

2. Description of the Related Art

Conventionally, in a semiconductor manufacturing factory, upgrading of production efficiency is strongly requested, in order to reduce the cost of product and increase the quantity of production. As part of this, with respect to the transporting facilities or utilities in the factory, improvements are requested in (i) the effective utilization of a clean room space, (ii) the reduction of construction cost, (iii) shortening of construction term, and (iv) shortening of transporting time period after the transporting facilities are in operation.

In the semiconductor manufacturing factory, a transporting carriage system such as an OHT (Over head Hoist Transport), an OHS (Over Head Shuttle) or the like, which travels on a track installed on the ceiling of the factory and transports the object.

As for this transporting carriage system, various researches and developments have been done. A work transporting system (i.e., an object transporting system) is disclosed in Japanese Patent Application Laid Open Publication No. Hei 10-109887. Here, the “work” means the transported object.

This work transporting system is provided with a ceiling traveling vehicle, which travels along a rail installed near the ceiling of the factory, and which moves a chuck device up and down by rotating the winding drum appropriately forwardly or reversely so as to wind up the belt onto the winding drum or wind off the belt from the winding drum. In this system, a storage rack member, on which the work is put, is installed above the floor and below the rail.

As a result, since the storage rack member is installed above the floor and below the rail, such effects can be obtained that space saving of the process station, the floor and so on can be realized and that the time period required for delivering and receiving the work by the ceiling traveling vehicle can be shortened.

### SUMMARY OF THE INVENTION

In general, a long time period and a great number of processes are required for the system architecture operation at the occasion of construction. One of these processes at the occasion of construction is a process of teaching a correction (i.e., a correction value) for a stop position of the transporting carriage at the storage rack.

The transporting carriage detects the stop position by virtue of a bar-code which is normally attached on the traveling track. In case of the transporting carriage before the process of teaching the correction for the stop position, the stop position and the put position of the transported object are inconsistent with each other. The degree of this inconsistency is different between transporting carriages, since there are (i) the error in the traveling direction, (ii) the error in the direction orthogonal to the traveling direction, (iii) the error in the carriage rotation direction and the like, and since those errors are different in magnitude between transporting carriages. Further, as for one transporting carriage, the degree of this inconsistency is different between storage racks, since the installation condition of the storage rack to the rail is different between storage racks. In the conventional technology disclosed in the above mentioned Japanese Patent Application Laid Open Publication, the correction values, which are different between storage racks, are manually inputted (i.e., taught) for respective one of the storage racks. The time period and the number of processes required for this teaching operation is enormous, since this teaching operation is to be performed for all the storage racks and for all the transporting carriages.

It is therefore an object of the present invention to provide a transported object storage system which can reduce the number of processes of teaching the correction for the position of the transporting carriage with respect to the storage rack.

The above object of the present invention can be achieved by a transported object storage system comprising: a transporting carriage for traveling along a track and transporting one or a plurality of objects each having a gripped portion; a transported object storage rack having a rack board; a positioning plate, which is disposed on the rack board and on which the transported objects can be put, having a plurality of groups of projections, each of the groups supporting respective one of the transported objects put on the positioning plate by engaging with a group of concave portions formed on a bottom surface of the respective one of the transported objects; and a plurality of code informations attached at predetermined intervals on the track, said transporting carriage comprising (i) a code information reading device for reading the plurality of code informations, (ii) a gripper for gripping the gripped portion and (iii) a correcting device for correcting a stop position of said transporting carriage along the track, the positioning plate being disposed at a predetermined position on the rack board in advance, so that a relative coordinate between each of the plurality of code informations and corresponding each of the groups of projections may be determined respectively, the transporting carriage being stopped on the basis of one of the plurality of code informations, so that an error amount between (i) the position of the gripped portion of the transported object put on one of the groups of projections and (ii) the position of the gripper of the stopped transporting carriage may be recorded as correction information in said correcting device, said correcting device correcting the stop position on the basis of the recorded correction information with respect to the other of the plurality of code informations.

According to the transported object storage system of the present invention, the transporting carriage travels along the track installed on a ceiling while gripping the object in a condition of suspending it for example. Below the track, the transported object storage rack, on which the transported object can be put, is installed, in such a condition of being suspended from the ceiling for example. The plurality of code informations are attached or bonded at predetermined intervals on an area of the track, which is above the transported object storage rack. The transporting carriage automatically travels while judging travel or stop by itself, on the basis of the attached code informations.

At the occasion of installing the transported object storage rack, one or a plurality of the positioning plates each having the group of projections are installed. Each of the positioning plates is disposed relative to the corresponding one of the code informations attached at the predetermined intervals. The error amount between (i) the coordinate of one of the positioning plates and (ii) the coordinate of the gripper of the transporting carriage, which has stopped on the basis of the relevant code information, is recorded by the correcting device.

In this case, at the occasion of installing the transported object storage rack, the correction information based on the one code information is recorded by the correcting device. Thus, this recorded correction information can be developed or applied to the other code information or informations, as those code informations including the one information are disposed at the predetermined intervals.

In this manner, according to the transported object storage system of the present invention, it is possible to provide such a transported object storage rack that the error in the relative position of the set of projections of the rack board, on which the transported object is put, with respect to the bar-code attached on the track can be ascribed as zero in a practical sense. Thus, it is possible to reduce or minimize the number of processes of teaching the positional correction of the transporting carriage regarding to the transported object storage rack.

In one aspect of the present invention, the track is installed on the ceiling, the gripper grips the gripped portion in a condition of suspending the gripped portion, the transported object storage rack is suspended from the track, and the plurality of code informations are attached on a lower portion of the track.

According to this aspect, the track is installed on the ceiling. The transported object storage rack is suspended from the track. The transported object can be gripped and suspended by the gripper, and can be put on the rack board. The code information attached on the lower portion of the track can be easily read by the code information reading device from the underneath. Thus, the transported object storage system installed on the ceiling can be realized.

In another aspect of the present invention, said correcting device has an external inputting device for externally inputting the error amount, which is to be recorded as the correction information in said correcting device.

According to this aspect, since the correcting device has the external inputting device, a fine adjustment can be performed in response to the error amount inputted from the external inputting device, and the result of the fine adjustment can be recorded as the correction information. Therefore, it is possible to set up the transported object storage system more easily and certainly.

In another aspect of the present invention, the relative coordinate puts on a vertical axis (i) a figure center of a figure comprising a set of projections among the projections, on which the transported object is put, as vertexes and (ii) corresponding one of the plurality of code informations.

According to this aspect, the figure center and the corresponding one of the code informations disposed at the predetermined intervals are disposed on the vertical axis. Thus, it is easy to perform the correction for the other of the code informations, by performing a correction so that the vertical axis may be coincident with a vertical axis of the gripper of the transporting carriage.

In another aspect of the present invention, the plurality of code informations comprise master bar-codes, and said code information reading device comprises a bar-code reader.

According to this aspect, it is easy to constitute the master bar-codes, and it is easy to read out the master bar-code by virtue of the bar-code reader. Thus, it is easy for the transporting carriage to automatically travel and stop.

In another aspect of the present invention, one or a plurality of positioning plates are installed, each of which comprises said positioning plate and can be fixed on the rack board individually.

According to this aspect, the positioning plate or plates can be fixed on the rack board individually from each other. Thus, it is possible to perform the positional adjustment of the group of projections after setting up the transported object storage rack, more easily than in the case of forming the group of projections directly on the transporting object storage rack.

In another aspect of the present invention, a plurality of transported object storage racks each comprising said transported object storage rack are installed along the track, and said correcting device corrects the stop position by using the correction information regarding to the transported object on one of said transported object storage racks, as the correction information on the other of said transported object storage racks.

According to this aspect, by correcting the relative positional relationships between (i) the track and each of the code informations and (ii) corresponding each of the transported object storage racks at the occasion of setting up all the transported object storage racks, it is possible to develop or apply the one correction information of one of the transported object storage racks, to the other of the transported object storage racks. As a result, it becomes not necessary to make a correction or adjustment individually, and the number of processes of setting up the transported object storage racks can be reduced. Thus, as for the whole of the transported object storage system, the efficiency of setting up can be improved. The time period for and the number of processes of setting up can be reduced.

In this aspect, the track may comprise a plurality of circular tracks and a track connecting the plurality of circular tracks, and said correcting device may correct, by using the correction information regarding to the transported object on one of said transported object storage racks installed within one of the circular tracks, the stop position on the other of said transported object storage racks within the one of the circular tracks.

In this case, the correction information of one of the transported object storage racks within the same circular track can be developed or applied to the other of the transported object storage racks within the same circular track. As a result, it becomes not necessary to correct the stop position of the transporting carriage regarding to the individual transported object storage racks within the same circular track. Thus, the number of processes of setting up the transported object storage racks can be reduced. Thus, as for the whole of the transported object storage system, the efficiency of setting up can be improved.

Alternatively, in this aspect, the track may comprise a plurality of circular tracks and a track connecting the plurality of circular tracks, and said correcting device may correct, by using the correction information regarding to the transported object on one of said transported object storage racks installed within one of the circular tracks, the stop position on the other of said transported object storage racks within the other of the circular tracks.

In this case, by making coincident the setting conditions of all the transported object storage racks within the same circular track as well as not within the same circular track, the correction information of one of the transported object storage racks within the same circular track can be developed or applied to the other of the transported object storage racks not within the same circular track (i.e., within the other of the circular tracks). As a result, it becomes not necessary to correct the stop position of the transporting carriage regarding to all the individual transported object storage racks regardless of the circular tracks. Thus, the number of processes of setting up the transported object storage racks can be reduced. Thus, as for the whole of the transported object storage system, the efficiency of setting up can be improved.

The nature, utility, and further features of this invention Will be more clearly apparent from the following detailed description with respect to preferred embodiments of the invention when read ill conjunction with the accompanying drawings briefly described below.

### BRIEF DESCRIPTION OF THE DRAWINGS

FIG. 1 is a schematic plan view of a transported object storage system as an embodiment of the present invention;

FIG. 2 is a side view of a transported object storage rack together with an OHT and a transported object, in the transported object storage system of FIG. 1;

FIG. 3 is a side view showing a process of installing the transported object storage rack of FIG. 2 to a rail;

FIG. 4A is a bottom view of the rail of FIG. 3, showing a condition of attaching a maser bar-code on the rail;

FIG. 4B is a sectional view of the rail of FIG. 4A;

FIG. 5 is a perspective view explaining a condition of disposing a positioning plate on a rack board in the embodiment;

FIG. 6A is a plan view showing one example of fixing the positioning plate;

FIG. 6B is a side view of FIG. 6A;

FIG. 7 is a side view of the transported object storage rack, explaining one example of a position correction teaching method for the transporting carriage, with respect to the transported object storage rack, which is performed at the occasion of system architecture in construction in the embodiment;

FIG. 8 is another side view of the transported object storage rack, explaining the example of the position correction teaching method;

FIG. 9 is another side view of the transported object storage rack, explaining how to teach the correction value to the transporting carriage, in the example of the position correction teaching method.

### DETAILED DESCRIPTION OF THE PREFERRED EMBODIMENTS

Referring to the accompanying drawings, an embodiment of the present invention will be now explained.

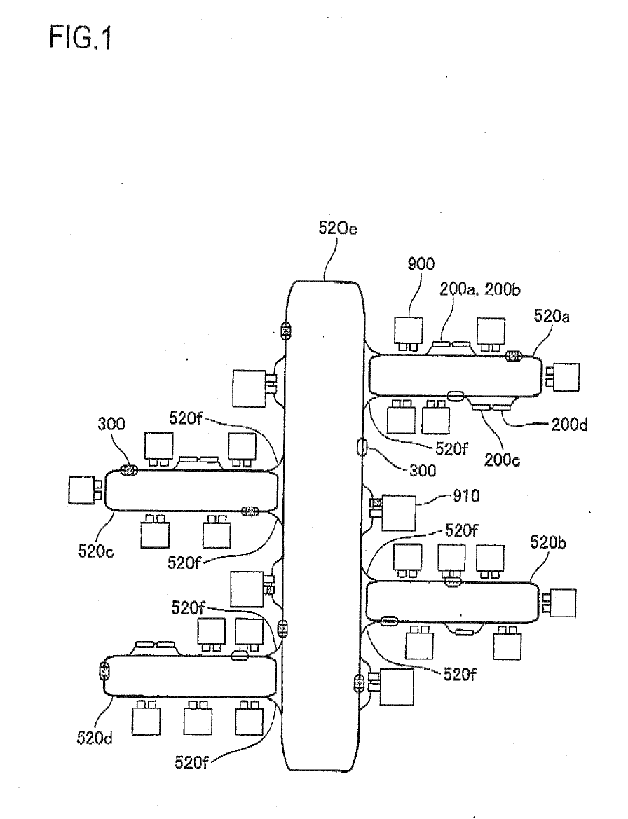

FIG. 1 shows an overall structure of a transported object storage system 100 as an embodiment of the present invention.

As shown in FIG. 1, the transported object storage system 100 is provided with a plurality of circular rails (i.e., intra-process tracks) 520a, 520b, 520c and 520d. The transported object storage system 100 is also provided with a circular rail (i.e., inter-process track) 520e striding over the circular rails 520a to 520d. Further, in the transported object storage system 100, the circular rails 520a to 520d and the circular rail 520e are connected with each other via connecting rails 520f.

By this, it is possible to drive an OHT type transporting carriage (simply referred to as an “OHT” hereinafter) 300, which will be described later in detail, in one direction without retreating, in the order of the rails 520a, 520f, 520e, 520f, 520b, 520f, 520e, 520f, 520d, 520f, 520e, 520f, 520c, 520f, 520e, 520a, . . . , for example.

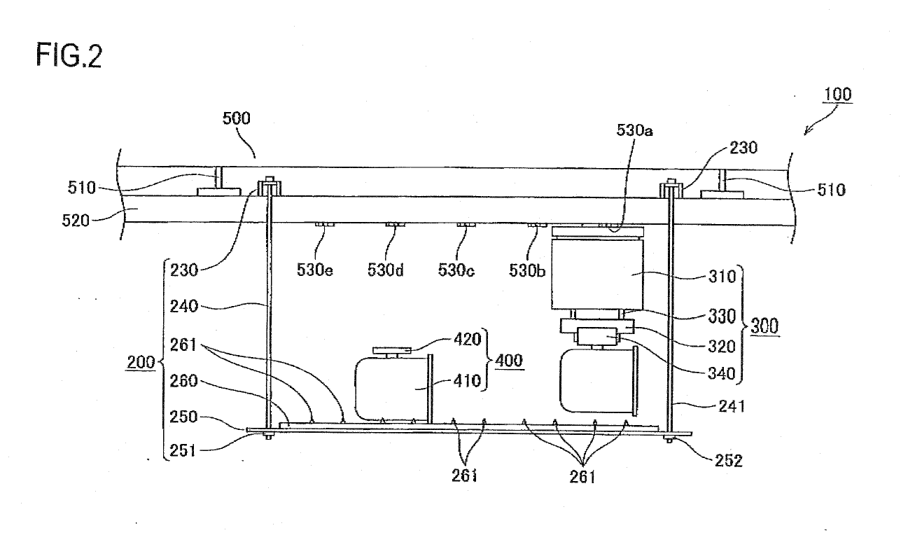

As shown in FIG. 1, at the peripheral of the circular rails 520a to 520d, a plurality of semiconductor processing equipments 900 are disposed. A plurality of semiconductor processing equipments 910 are disposed in a sideway of the circular rail 520e. A plurality of transported object storage racks 200 (200a, 200b, 200c, 200d, . . . ), one of which is shown in FIG. 2 for example, are also disposed along the plurality of circular rails 520a to 520d.

The OHT 300 puts a FOUP 400, which is one example of the “transported objects” and will be described later in detail, on the transported object storage rack 200, and transports the FOUP 400, while traveling on the rails 520a to 520d. By this, substrates contained in the FOUP 400 are taken out by a hand of the semiconductor processing equipment 900, are subjected to a predetermined process, and are contained into the FOUP 400. Then, the FOUP 400 is transported by the OHT 300, so that the predetermined processes are sequentially applied to the substrates in the FOUP 400.

FIG. 2 shows a detailed structure of the transported object storage rack 200.

In FIG. 2 the transported object Storage system 100 is mainly installed on a ceiling 500. A rail 520 is build from the ceiling 500 through a suspending member 510. The rail 520 is build circularly. The rail 520 diverges at a middle of the route toward a plurality of destinations. At a vicinity of the diverging point, the transported object storage rack 200 is disposed. A plurality of code informations (hereinafter, referred to as “master bar-codes”) 530a to 530e are attached at predetermined intervals. The master bar-codes 530a to 530e will be described later in detail.

The transported object storage rack 200 is disposed in a condition of being suspended below the rail 520. More concretely, one end of each of hanging members 240 and 241 is disposed on the rail 520 through respective one of supporting members 230 in a vertically downward direction. The other end of the handing member 240 is fixed on one end of a rack board 250 by a nut 251. The other end of handing member 241 is fixed on the other end of the rack board 250 by a nut 252. By this, the rack board 250 is set in parallel to a horizontal plane.

On a surface of the rack board 250 facing to the rail 520, one or a plurality of positioning plates 260 are disposed. The positioning plate 260 comprises a plate shaped member, on which a plurality of kinematic pins 261 are disposed as described later in detail. Therefore, on the surface of the rack board 250, one or a plurality of the positioning plates 260 are laid.

Next, the OHT 300 will be explained below, which moves in a condition of being suspended to the rail 520.

The OHT 300 is provided with a main body portion 310, an elevator device 320, a suspending belt 330 and a gripper 340. The OHT 300 is capable of traveling along the rail 520, and moving up and down the elevator 320 by virtue of the suspending belt 330. At the lower portion of the elevator device 320, there is disposed the gripper 340. The gripper 340 has such a shape as to grip a flange 420 (which is one example of the “gripped portion” of the present invention) of the FOUP 400 as describe later in detail. For example, the gripper 340 comprises a pair of pinching members for pinching the flange 420 from the left and right directions.

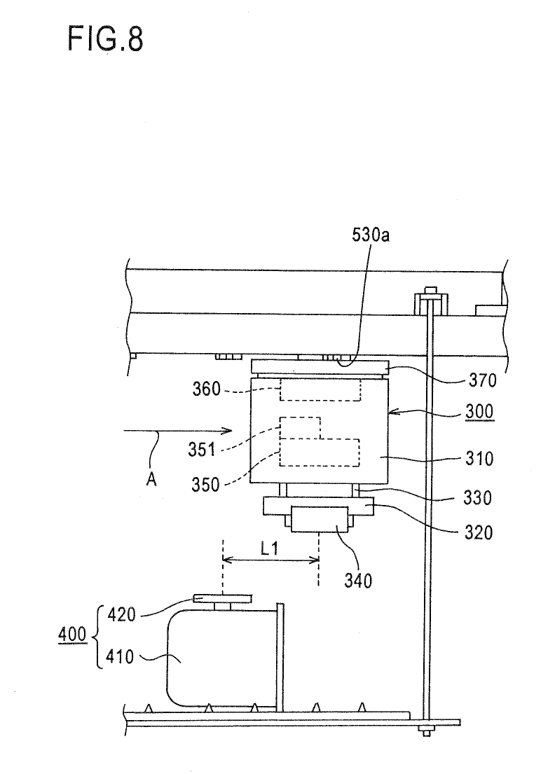

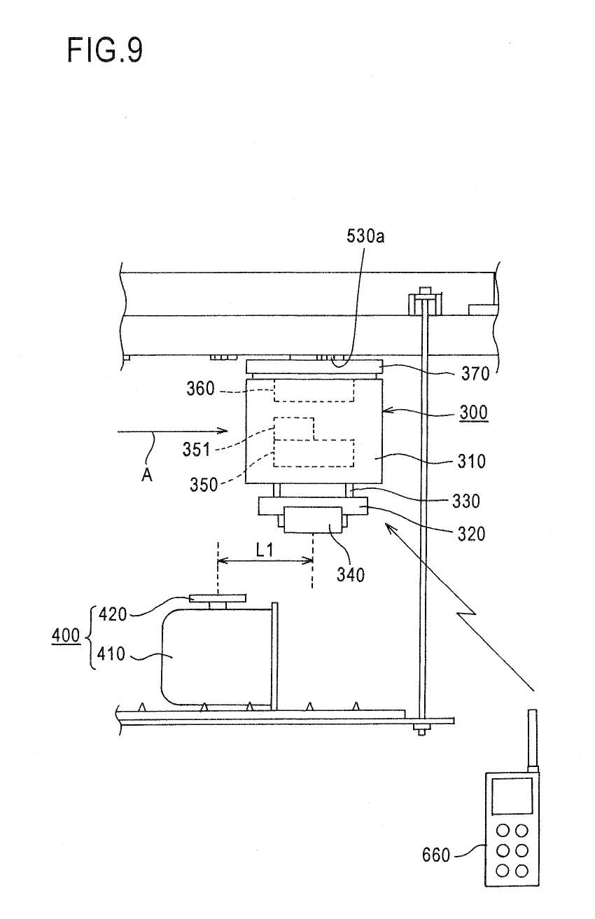

The OHT 300 includes a controlling device 350, a correcting device 351 and data reading device (hereinafter referred to as “bar-code reader”) 360 (as illustrated in FIG. 8). The controlling device 350 controls the driving and stopping operations of a driving device 370, on the basis of the read data from the bar-code reader 360. Further, the controlling device 350 controls the winding up and winding off operations of the suspending belt 330, and also instructs the operation of the gripper 340. The correcting device 351 gives the correction information to the controlling device 350. The details of the correcting device 351 will be described later. The OHT 300 is also provided with a receiver device for receiving a signal from an external input operating portion 660 (refer to FIG. 9). The controlling device 350 gives the instruction from the external input operating portion 660 to the correcting device 351. The correcting device 351 records the given instruction as the correction information. The controlling device 850 corrects the driving and stopping control of the driving device 370 in accordance with the instruction. Here, the external input operation portion 660 is a portable remote controller, a forward and reverse switch or the like.

Next, the FOUP (Front-Opening Unified Pod) 400 as one example of the transported object will be explained. Here, the FOUP is prescribed by SEMI standard E47.1. The FOUP is a carrier with the purpose of transporting and storing 300 mm (millimeters) wafer used in the semiconductor factory of the mini-environment method, and is a storage box or container for the front opening cassette transporting.

The FOUP 400 is provided with a main body portion 410 and a flange 420. The main body portion 410 has a box shape capable of containing the transported object. The wafer or wafers are contained in the internal space of this box shape. The main body portion 410 has at the lower surface thereof concave portions, which are to engage with the projections of convex portions of the kinematic pins 261 of the positioning plate 260.

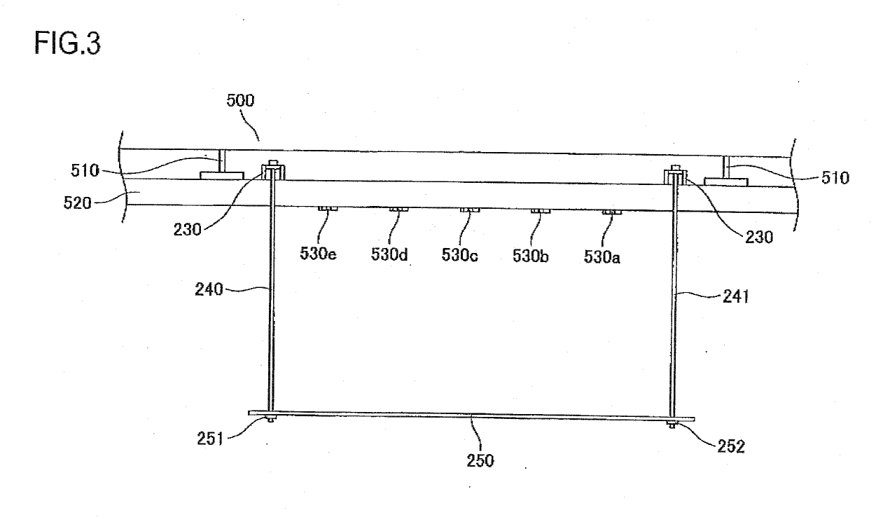

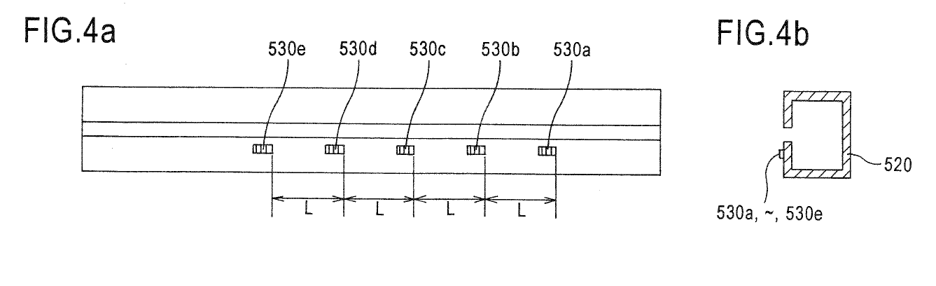

Next, processes at the occasion of setting the transported object storage system 100 will be explained below. FIG. 3 shows a process of installing the transported object storage rack 200 to the rail 520. FIGS. 4A and 4B show a condition of attaching the maser bar-codes 530a to 530e on the rail 520. FIG. 4A shows the condition from the underneath of the bottom surface of the rail 520, while FIG. 4B shows the cross section of the rail 520.

As shown in FIG. 3, the hanging members 240 and 241 as well as the rack board 250 are installed. Then, as shown in FIG. 4A, the master bar-codes 530a to 530e are attached on the rail 520, at the predetermined interval L. In this case, as shown in FIG. 4B, the rail 520 has a C character shape with the internal space thereof being vacant. The master bar-codes 530a to 530e are attached on the surface of the rail 520 in the vertically downward direction.

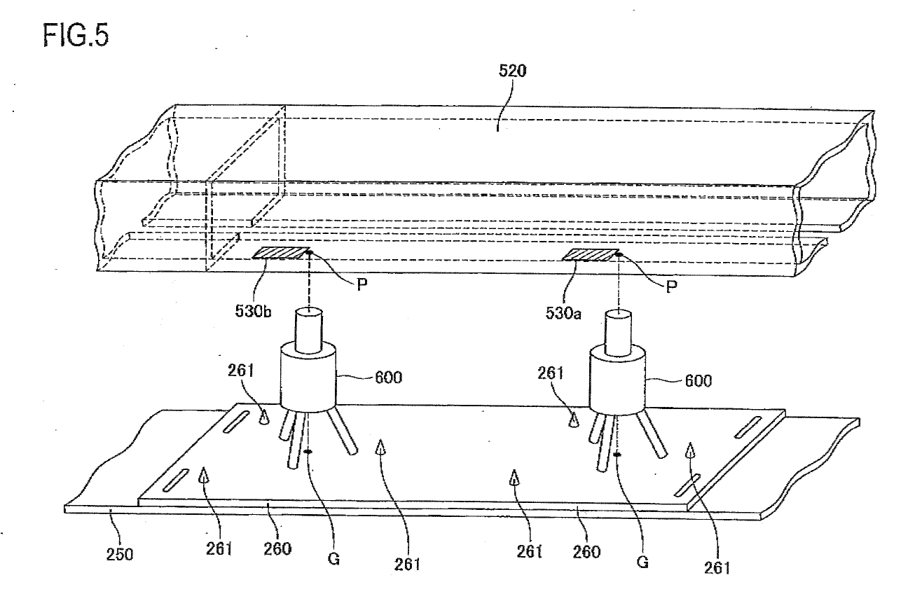

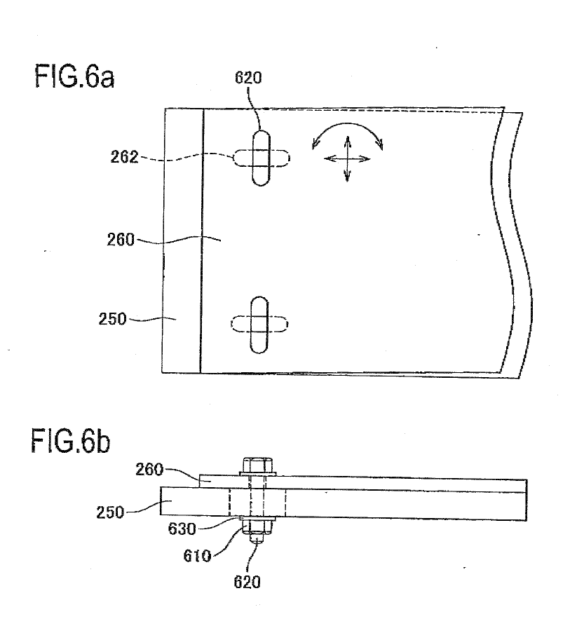

Next, FIG. 5 shows a condition of disposing the positioning plate 260 on the rack board 250. FIGS. 6A and 6B show one example of fixing the positioning plate 260. FIG. 6A shows the plan view of the positioning plate 260, while FIG. 6B is the side view thereof.

As shown in FIG. 5, the positioning plate 260 is disposed on the surface of the rack board 250. The positioning plate 260 has a rectangular shape, and is provided with a plurality of sets of the kinematic pins 261, such that three kinematic pins 261 are one set for one plate. For example, in FIG. 5, two sets of kinematic pins 261 (wherein each of these two set comprises three kinematic pins 261) are disposed on one plate of the positioning plate 260.

Then, as shown in FIGS. 6A and 6B, a washer 630 is pinched with respect to a longitudinal aperture 262 formed in the positioning plate 260, and the temporary joint is established by a nut 610 with a bolt 620 penetrating therethrough.

Next, as shown in FIG. 5, a position pointer 600 is used to match the vertical light irradiated from the position pointer 600 with an end portion P of each of the bar-codes 530a to 530e. By this, the light in the vertically downward direction irradiated from the position pointer 600 appears as a light point on an upper portion of the positioning plate 260. In this case, the adjustment is conducted by moving the position of the positioning plate 260 in the horizontal and rotational arrows in FIG. 6A so that the gravity center position G (i.e., the “figure center” or the “centroid”) of three kinematic pins 261 may be coincident with the light point of the position pointer 600. Namely, according to this attaching method of the positioning plate 260, the positioning can be conducted with such an accuracy that the error in the mutual position between (i) each of a plurality of sets of projections on which the FOUP 400 is to be put, and (ii) the corresponding each of the bar-codes 530a to 530e, which are attached on the track opposing to those projections respectively, can be ascribed to be zero in a practical sense.

After the adjustment of positioning of the positioning plate 260 is finished, the nut 610, which was temporally fixed in advance, is tighten up with a predetermined rotational torque, so that the positioning plate 260 is fixed to the rack board 250.

Incidentally, although the position pointer 600 which irradiates the laser beam is employed in this embodiment, it is not limited to this. For example, the position pointer may be a sash weight at a tip of string or the like. Further, the positioning plate 260 has the rectangular shape in the embodiment, it is not limited to this. For example, the positioning plate 260 may have other arbitrary shape.

Next, the positional adjustment of the OHT 300 after the transported object storage system 100 is set, will be explained below.

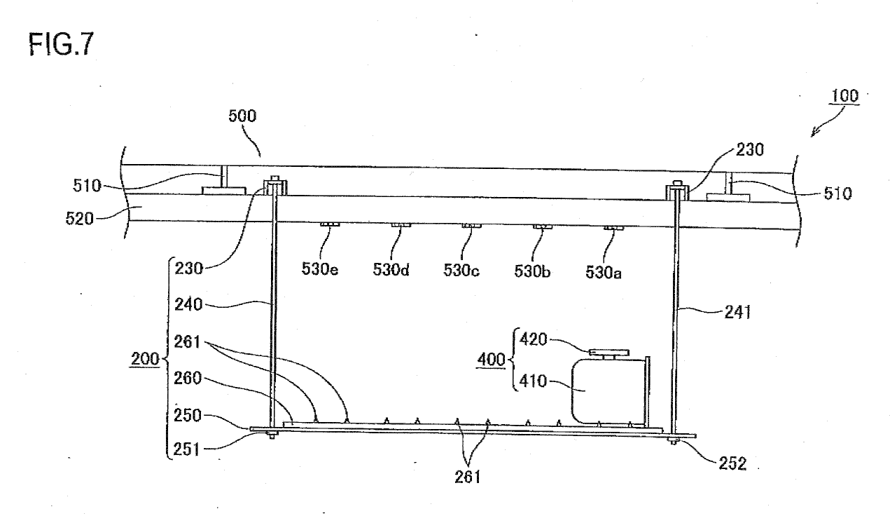

FIG. 7 and FIG. 8 show one example of a position correction teaching method for the transporting carriage, with respect to the storage rack, which is performed at the occasion of system architecture in construction in the embodiment.

As shown in FIG. 7, the FOUP 400 is manually put on the kinematic pins 261. Here, since the bottom surface of the FOUP 400 has the concave portions which are capable of engaging with the three kinematic pins 261, the kinematic pins 261 are engaged with those concave portions.

As shown in FIG. 8, the OHT 300 moves along the rail 520 in the direction of an arrow A. Then, a bar-code reader 360 incorporated in the OHT 300 reads the master bar-code 530a, so that the OHT 300 stops by the action of the controlling device 350.

As shown in FIG. 8, it is assumed that an error L1 occurs between (i) the central axis in the vertical direction of the gripper 340 at the stop position of the OHT 300 and (ii) the central axis in the vertical direction of the flange 420 of the FOUP 400. In this case, in order to put and/or transport the FOUP 400 in stable, it is required to adjust or correct the error L1 by the driving device of the OHT 300.

Namely, in the OHT 300 in FIG. 8, the error L1 becomes the correction value. This adjustment is not only for the direction of the arrow A, but normally also for the combination of the traveling direction, the direction orthogonal to the traveling direction, the rotating direction and the height direction.

Next, the method of teaching the correction value to the OHT 300 will explained below with referring to FIG. 9. FIG. 9 shows how to teach the correction value to the OHT 300.

As shown in FIG. 9, the external input operating portion 660 is used for teaching. In teaching, at first, the operator (i.e., the person to operate) makes the correcting device 351 memorize the coordinate values (X0, Y0, Z0, θ 0) of the present position where the OHT 300 currently stops, by operating the external input operating portion 660.

Next, the operator operates the external input operating portion 660 such that the OHT 300 is moved to a formal position, at which the gripper 340 can correctly grip the flange 420 of the FOUP 340.

In FIG. 9, the movement amount required in the moving operation is represented by the error L1. Normally, as the error L1, the movements in the perpendicular direction, the up and down direction, and the rotating direction are also required. After the movement of the OHT 300 to the formal position, the external input operating portion 660 is operated so that the coordinate values (X1, Y1, Z1, θ 1) at the stop position of the OHT 300 after the movement may be memorized by the correcting device 351. The difference between the coordinate values (X0, Y0, Z0, θ O) memorized in advance and the coordinate values (X1, Y1, Z1, θ 1) memorized at this time becomes the correction value Thus, the external input operating portion 660 is operated so that this correction value may be calculated by the correcting device 351, and may be memorized (i.e., recorded) by the correcting device 351. Such an operation that the correcting device 351 memorizes the correction value in this manner is the teaching operation.

The OHT 300 controls the driving of the OHT 300 with using the error L1, which is recorded in the correcting device 351, as the coordinate values. Here, since the master bar-codes 530a to 530e are arranged at equal intervals and since the positions of the master bar-codes 530a to 530e and the positioning plate 260 are precisely matched with each other, the error of the master bar-codes 530b to 530e becomes the correction values (i.e., the error L1) same as in the case of the master bar-code 530a. Therefore, there is no need to perform the adjustment or correction of the error at a plurality of times. It is possible to put and/or transport the FOUP 400 in stable in a short time period by the OHT 300.

As described above in detail, in the transported object storage system 100, the correction information (i.e., the error L1) based on one master bar-code i.e., the master bar-code 530a, is recorded in the correcting device 351. Then, the controlling device 350 can develop or apply this correction information to the equally spaced master bar-codes 530b to 530e. On the other hand, since a plurality of sets of the kinematic pins 261 are formed in one body to one positioning late i.e., the positioning plate 260, it is not necessary to position the kinematic pins 261 individually for each FOUP 400. Thus, it is possible to reduce the number of processes of setting the transported object storage system 100 (especially, reduce the time period for teaching).

The teaching can be performed by use of the external input operating portion 660 (e.g., a portable remote controller or the like), and the correction information can be recorded. Thus, it is possible to set up the transported object storage system 100 more easily and certainly.

In this case, the master bar-codes 530a to 530e, one of which is disposed at the figure center of the figure (i.e., the centroid of the graphic form) formed by the apexes of one set of the projections on which the FOUP 400 is put, and which are equally spaced, are disposed on the vertical axis. Then, this vertical axis is corrected so that the gripper 30 of the OUT 300 can appropriately grip the FOUP 400. Thus, it is possible to easily perform the correction to other master bar-codes 530b to 530e.

In this case, the positioning plates 260 comprising a plurality of plates or sheets can be fixed to the transported object storage rack 200 independently from each other. Thus, as compared with such a case that the kinematic pins 261 are directly formed on the transported object storage rack 200, it is possible to easily adjust the placement of the kinematic pins 261 after the transported object storage rack 200 is built.

In the transported object storage system 100, since the correction information (error L1) based on the one master bar-code 530a is recorded in the correcting device 351, the controlling device 350 can develop this correction information for the correction of the stop position of the OHT 300 as for each of other transported object storage racks 200 within the same track (i.e., along the same rail 520a). As a result, it is not necessary to individually teach the stop position of the OHT 300 to each of the transported object storage racks 200 within the same track. It is possible to reduce the number of processes of setting the transported object storage system 100 (especially reduce the teaching process and the teaching time period).

Further, in the transported object storage system 100, since the correction information (error L1) based on the one master bar-code 530a is recorded in the correcting device 351, by unifying the setting conditions of all the transported object storage racks 200 in the transported object storage system 100, the controlling device 350 can develop or apply this correction information for the correction of the stop position of the OHT 300 as for each of other transported object storage racks 200 without the same track. As a result, it is not necessary to individually teach the stop position of the OHT 300 to each of the transported object storage racks 200 without the same track. It is possible to reduce the number of processes of setting the transported object storage system 100 (especially reduce the teaching process and the teaching time period).

Incidentally, in the present embodiment, each of the positioning plates 260 has the uniform rectangular shape. However, it is not limited to this. Instead, it may have any of other arbitrary shapes. Further, other members or convex portions may be employed in stead of the kinematic pins 261,

Further, in the transported object storage system 100, the master bar-code is employed as the code information, and the bar-code reader is employed as the code information reading device. However, it is not limited to this. Instead, any of other arbitrary code information such as the IC tag (i.e., REID), the two dimensional bar-code and so on may be employed.

In the present embodiment, the rail 520 corresponds to the “track”. The FOUP 400 corresponds to the “transported object”. The OHT 300 corresponds to the “transporting carriage”. A plurality of kinematic pins 260 correspond to the “group of projections”. The master bar-codes 530a to 530e correspond to “a plurality of code information”. The bar-code reader 360 and the data reading device correspond to the “code information reading device”. The flange 420 corresponds to the “gripped portion”. The error L1 corresponds to the “error amount”. The external input operating portion 660 (e,g., the portable remote controller) corresponds to the “external inputting device”. The gravity center G of the three kinematic pins 261 corresponds to the “figure center (centroid)” of the present invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2006-237198 filed on Sep. 1, 2006 including the specification, claims, drawings and summary is incorporated herein by reference in its entirety.

What is claimed is:

1. A transported object storage system comprising:
a transporting carriage for traveling along a track and transporting one or a plurality of objects each having a gripped portion;
a transported object storage rack having a rack board;
a positioning plate, which is disposed on the rack board and on which the transported objects can be put, having a plurality of groups of projections, each of the groups supporting respective one of the transported objects put on the positioning plate by engaging with a group of concave portions formed on a bottom surface of the respective one of the transported objects; and
a plurality of code informations attached at predetermined intervals on the track,
said transporting carriage comprising (i) a code information reading device for reading the plurality of code informations, (ii) a gripper for gripping the gripped portion and (iii) a correcting device for correcting a stop position of said transporting carriage along the track,
the positioning plate being disposed at a predetermined position on the rack board in advance, so that a relative coordinate between each of the plurality of code informations and corresponding each of the groups of projections may be determined respectively,
the transporting carriage being stopped on the basis of one of the plurality of code informations, so that an error amount between (i) the position of the gripped portion of the transported object put on one of the groups of projections and (ii) the position of the gripper of the stopped transporting carriage may be recorded as correction information in said correcting device,
said correcting device correcting the stop position on the basis of the recorded correction information with respect to the other of the plurality of code informations.

2. The transported object storage system according to claim 1, wherein
the track is installed on the ceiling,
the gripper grips the gripped portion in a condition of suspending the gripped portion,
the transported object storage rack is suspended from the track, and
the plurality of code informations are attached on a lower portion of the track.

3. The transported object storage system according to claim 1, wherein said correcting device has an external inputting device for externally inputting the error amount, which is to be recorded as the correction information in said correcting device.

4. The transported object storage system according to claim 1, wherein the relative coordinate puts on a vertical axis (i) a figure center of a figure comprising a set of projections among the projections, on which the transported object is put, as vertexes and (ii) corresponding one of the plurality of code informations.

5. The transported object storage system according to claim 1, wherein
the plurality of code informations comprise master bar-codes, and
said code information reading device comprises a bar-code reader.

6. The transported object storage system according to claim 1, wherein one or a plurality of positioning plates are installed, each of which comprises said positioning plate and can be fixed on the rack board individually.

7. The transported object storage system according to claim 1, wherein
a plurality of transported object storage racks each comprising said transported object storage rack are installed along the track, and
said correcting device corrects the stop position by using the correction information regarding to the transported object on one of said transported object storage racks, as the correction information on the other of said transported object storage racks.

8. The transported object storage system according to claim 7, wherein
the track comprises a plurality of circular tracks and a track connecting the plurality of circular tracks, and
said correcting device corrects, by using the correction information regarding to the transported object on one of said transported object storage racks installed within one of the circular tracks, the stop position on the other of said transported object storage racks within the one of the circular tracks.

9. The transported object storage system according to claim 7, wherein
the track comprises a plurality of circular tracks and a track connecting the plurality of circular tracks, and
said correcting device corrects, by using the correction information regarding to the transported object on one of said transported object storage racks installed within one of the circular tracks, the stop position on the other of said transported object storage racks within the other of the circular tracks.
